(19) United States
(12) Patent Application Publication
(10) Pub. No.: US 2025/0371040 A1
(43) Pub. Date: Dec. 4, 2025

(54) LOCATION SET GENERATION METHOD AND APPARATUS, ELECTRONIC DEVICE, AND COMPUTER-READABLE STORAGE MEDIUM

(71) Applicant: TENCENT TECHNOLOGY (SHENZHEN) COMPANY LIMITED, Shenzhen (CN)

(72) Inventors: Rui HU, Shenzhen (CN); Jiayin ZHANG, Shenzhen (CN)

(21) Appl. No.: 19/300,355

(22) Filed: Aug. 14, 2025

Related U.S. Application Data
(63) Continuation of application No. PCT/CN2024/079116, filed on Feb. 28, 2024.

(30) Foreign Application Priority Data
Jul. 5, 2023 (CN) 202310824022.9

(51) Int. Cl. G06F 16/29; G06F 3/04847

(52) U.S. Cl. CPC G06F 16/29; G06F 3/04847

(57) ABSTRACT

A location set generation method includes: determining location set source information in response to a trigger operation on a location set creation entry on an application program interface; extracting location information from the location set source information, and generating, by using the extracted location information, a location information set associated with the location set source information; displaying a map interface, where the map interface includes a map information region and a set information region; and adding marks to a plurality of locations in the location information set, displaying, in the map information region, the plurality of locations and the marks, and displaying the location information set in the set information region.

### CROSS-REFERENCES TO RELATED APPLICATIONS

This application is a continuation of PCT Application No. PCT/CN2024/079116, filed on Feb. 28, 2024, which claims priority to Chinese Patent Application No. 202310824022.9 filed on Jul. 5, 2023, the entire contents of all of which are incorporated herein by reference.

### FIELD OF THE TECHNOLOGY

The present disclosure relates to map software technologies, and in particular, to a location set generation method and apparatus, an electronic device, and a computer-readable storage medium.

### BACKGROUND OF THE DISCLOSURE

Map software can not only provide a user with services such as map query and route navigation, but also provide the user with a collection service of location information. In this way, in the map software, the user can group locations of interest into location sets according to different types, thereby facilitating subsequent queries about position relationships of locations in a set, and facilitating route calculation, navigation and the like for the locations.

When generating a location information set, in many map software, the user manually adds specific location information to the location information set. However, complex manual operations need to be performed to generate the location information set, leading to low efficiency of generating the location information set.

### SUMMARY

The embodiments of the present disclosure provide a location set generation method and apparatus, an electronic device, a computer-readable storage medium, and a computer program product, to increase efficiency of generating a location information set.

The technical solutions of the embodiments of the present disclosure are implemented as follows:

An embodiment of the present disclosure provides a location set generation method, applied to an electronic device, and including: determining location set source information in response to a trigger operation on a location set creation entry on an application program interface, where the location set source information is configured for automatic extraction of location information; extracting location information from the location set source information, and generating, by using the extracted location information, a location information set associated with the location set source information; displaying a map interface, where the map interface includes a map information region and a set information region; and displaying, in the map information region, a plurality of locations in the location information set and marks corresponding to the plurality of locations.

An embodiment of the present disclosure provides a location set generation apparatus, including: a source information determination module, configured to determine location set source information in response to a trigger operation on a location set creation entry on an application program interface, where the location set source information is configured for automatic extraction of location information; a set generation module, configured to: extract location information from the location set source information, and generate, by using the extracted location information, a location information set associated with the location set source information; and a content display module, configured to: display a map interface, where the map interface includes a map information region and a set information region; and display, in the map information region, a plurality of locations in the location information set and marks corresponding to the plurality of locations, and display the location information set in the set information region.

An embodiment of the present disclosure provides an electronic device, including: a memory, configured to store computer-executable instructions; and a processor, configured to implement, when executing the computer-executable instructions stored in the memory, the location set generation method according to the embodiments of the present disclosure.

An embodiment of the present disclosure provides a non-transitory computer-readable storage medium, having computer-executable instructions stored therein, where when the computer-executable instructions are executed by a processor, the location set generation method according to the embodiments of the present disclosure is implemented.

An embodiment of the present disclosure provides a computer program product, including a computer program or computer-executable instructions, where when the computer program or the computer-executable instructions are executed by a processor, the location set generation method according to the embodiments of the present disclosure is implemented.

The embodiments of the present disclosure have the following beneficial effects: After a user performs a trigger operation on a location set creation entry, an electronic device first determines location set source information which is specified by the user and is configured for extracting location information, then automatically extracts location information from the location set source information, and uses the extracted location information to form a location information set, to replace a manual information input process in the related art with an automatic information extraction process, and complete generation of the location information set with one click. Therefore, operations required for creating the location information set can be simplified, thereby improving the efficiency of generating a new location set.

### BRIEF DESCRIPTION OF THE DRAWINGS

FIG. 1 is a schematic architectural diagram of a location set generation system according to an embodiment of the present disclosure.

FIG. 2 is a schematic structural diagram of a terminal according to an embodiment of the present disclosure.

FIG. 3 is a first schematic flowchart of a location set generation method according to an embodiment of the present disclosure.

FIG. 4 is a second schematic flowchart of a location set generation method according to an embodiment of the present disclosure.

FIG. 5 is a schematic diagram of a display process of an information type identifier according to an embodiment of the present disclosure.

FIG. 6 is a schematic diagram of a process of determining text information as location set source information according to an embodiment of the present disclosure.

FIG. 7 is a schematic diagram of a process of determining image information as location set source information according to an embodiment of the present disclosure.

FIG. 8 is a schematic diagram of display of a location creation set entry according to an embodiment of the present disclosure.

FIG. 9 is a schematic diagram of laying out a map interface in two different manners according to an embodiment of the present disclosure.

FIG. 10 is a schematic diagram of display of location information and a location information set according to an embodiment of the present disclosure.

FIG. 11 is a third schematic flowchart of a location set generation method according to an embodiment of the present disclosure.

FIG. 12 is a schematic diagram of display of an information editing window according to an embodiment of the present disclosure.

FIG. 13 is a fourth schematic flowchart of a location set generation method according to an embodiment of the present disclosure.

FIG. 14 is a schematic diagram of a proofreading preview window according to an embodiment of the present disclosure.

FIG. 15 is a first processing flowchart of generating a location set according to an embodiment of the present disclosure.

FIG. 16 is a flowchart of interaction between a server and a terminal in a location set generation process according to an embodiment of the present disclosure.

FIG. 17 is a second processing flowchart of generating a location set according to an embodiment of the present disclosure.

### DESCRIPTION OF EMBODIMENTS

To make the objectives, technical solutions, and advantages of the present disclosure clearer, the following further describes the present disclosure in detail with reference to the accompanying drawings. The described embodiments are not to be considered as a limitation to the present disclosure. All other embodiments obtained by a person of ordinary skill in the art without any creative effort shall fall within the protection scope of the present disclosure.

In the following descriptions, related “some embodiments” describe subsets of all possible embodiments. However, the “some embodiments” may be the same subset or different subsets of all the possible embodiments, and may be combined with each other without conflict.

In the following descriptions, the related term “first/second/third” is merely intended to distinguish similar objects but does not necessarily indicate a specific order of an object. “First/second/third” is interchangeable in terms of a specific order or sequence if permitted, so that the embodiments of the present disclosure described herein can be implemented in a sequence in addition to the sequence shown or described herein.

In the embodiments of the present disclosure, the term “module” or “unit” refers to a computer program having a predetermined function or a part of a computer program and works together with other related parts to achieve a predetermined objective, and may fully or partially implement the predetermined objective by using software, hardware (such as a processing circuit or a memory), or a combination thereof. Similarly, a processor (or a plurality of processors or memories) may be configured to implement one or more modules or units. In addition, each module or unit may be a part of an overall module or unit including a function of the module or unit.

Unless otherwise defined, meanings of all technical and scientific terms used in this specification are the same as those usually understood by a person skilled in the art to which the present disclosure belongs. Terms used in this specification are merely intended to describe objectives of the embodiments of the present disclosure, but are not intended to limit the present disclosure.

Before the embodiments of the present disclosure are further described in detail, a description is made on nouns and terms involved in the embodiments of the present disclosure, and the nouns and terms involved in the embodiments of the present disclosure are applied to the following explanations.
1) Location set source information refers to source information specified by a user and configured for automatically extracting corresponding location information, that is, the location set source information is information that implicitly includes the location information and that has not been processed. In the embodiments of the present disclosure, the location set source information may be image information, text information, or audio information.
2) Location information set refers to a set formed by the location information extracted from the location set source information. In the embodiments of the present disclosure, an association relationship exists between target location information and the location set source information, that is, each piece of location information in the location information set is determined based on the location set source information.
3) “In response to” is configured for representing a condition or a status on which a to-be-performed operation depends. When the condition or the status is satisfied, one or more to-be-performed operations may be performed immediately or after a set delay. Unless explicitly stated, there is no limitation on the chronological order between the plurality of to-be-performed operations.

Map software can not only provide a user with services such as map query and route navigation, but also provide the user with a collection service of location information. In this way, in the map software, the user can group locations of interest according to different types, thereby facilitating subsequent query of a position relationship of locations in a set, and route calculation, navigation and the like for the locations.

In the related art, when generating a location information set, in most map software, the user manually adds specific location information to the location information set. That is, when the user needs to create a location information set, the user needs to search for location information in information such as text or a picture repeatedly and one by one, and collect the location information one by one, to form the location information set. In the related art, the location information set can be generated through complex manual operations, leading to low efficiency of generating the location information set.

The embodiments of the present disclosure provide a location set generation method and apparatus, an electronic device, a computer-readable storage medium, and a computer program product, to increase efficiency of generating a location information set. The following describes exemplary applications of an electronic device according to the embodiments of the present disclosure and configured to generate a location information set. The electronic device provided in the embodiments of the present disclosure may be implemented as various types of terminals such as a notebook computer, a tablet computer, a desktop computer, a set-top box, or a mobile device (for example, a mobile phone, a portable music player, a personal digital assistant, a dedicated messaging device, or a portable game device), may be implemented as a server, or may be implemented as a device cluster formed by a terminal and a server. An exemplary application that the electronic device is implemented as a terminal is described in the following.

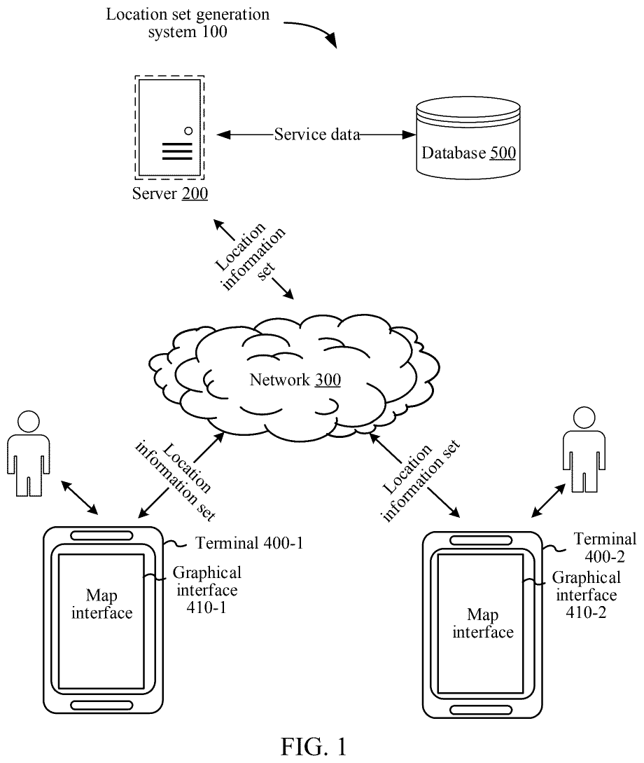

Referring to FIG. 1, FIG. 1 is a schematic architectural diagram of a location set generation system according to an embodiment of the present disclosure. To support a location set generation application, in the location set generation system 100, a terminal (a terminal 400-1 and a terminal 400-2 are exemplarily shown) is connected to a server 200 through a network 300. The network 300 may be a wide area network, a local area network, or a combination thereof. A database 500 is further arranged in the location set generation system 100, and is configured to provide data support for the server 200. The database 500 may be independent of the server 200, or may be configured in the server 200. FIG. 1 shows a case in which the database 500 is independent of the server 200.

The terminal 400-1 and the terminal 400-2 are respectively configured to: determine location set source information in response to a trigger operation on a location set creation entry on an application program interface displayed by a graphical interface 410-1 and a graphical interface 410-2; extract location information from the location set source information, to obtain a location information set associated with the location set source information; display a map interface on the graphical interface 410-1 and the graphical interface 410-2, display, in a map information region, each piece of location information in the location information set and mark information of the each piece of location information (i.e., a plurality of locations in the location information set and marks corresponding to the plurality of locations), and display the location information set in a set information region; and store the location information set, and transmit the location information set to the server 200 by using the network 300 for cloud backup.

The server 200 is configured to back up and store the location information sets transmitted by the terminal 400-1 and the terminal 400-2.

The embodiments of the present disclosure may be implemented by using a cloud technology. The cloud technology is a hosting technology that unifies a series of resources such as hardware, software, and networks in a wide area network or a local area network to implement computing, storage, processing, and sharing of data.

The cloud computing is a collective name of a network technology, an information technology, an integration technology, a management platform technology, an application technology, and the like based on an application of a cloud computing business mode, and may form a resource pool, which is used as required, and is flexible and convenient. The cloud computing technology becomes an important support. A system background service of a technical network requires a large amount of computing and storage resources, and needs to be implemented by using the cloud computing.

Exemplarily, the server 200 may be an independent physical server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform. The terminal 400-1 and the terminal 400-2 each may be a smartphone, a tablet computer, a notebook computer, a desktop computer, a smart speaker, a smartwatch, a smart home appliance, an in-vehicle terminal, or the like, but are not limited thereto. The terminal and the server may be directly or indirectly connected in a wired or wireless communication manner. This is not limited in this embodiment of the present disclosure.

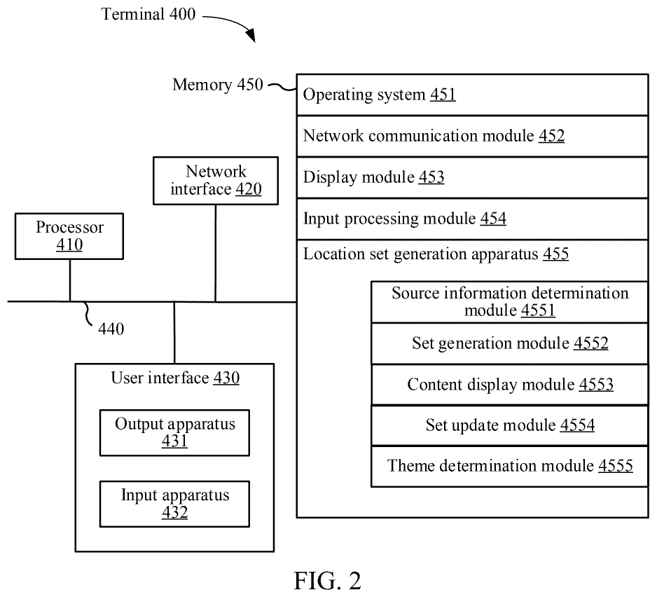

Referring to FIG. 2, FIG. 2 is a schematic structural diagram of a terminal (an implementation of an electronic device) according to an embodiment of the present disclosure. The terminal 400 shown in FIG. 2 includes at least one processor 410, a memory 450, at least one network interface 420, and a user interface 430. All the components in the terminal 400 are coupled together by a bus system 440. The bus system 440 is configured to implement connection and communication between the components. In addition to a data bus, the bus system 440 further includes a power supply bus, a control bus, and a state signal bus. However, for ease of clear description, all types of buses in FIG. 2 are marked as the bus systems 440.

The processor 410 may be an integrated circuit chip having a signal processing capability, for example, a general purpose processor, a digital signal processor (DSP), or another programmable logic device, a discrete gate, a transistor logical device, or a discrete hardware component. The general purpose processor may be a microprocessor, any hardware processor, or the like.

The user interface 430 includes one or more output apparatuses 431 that can display media content, including one or more loudspeakers and/or one or more visual display screens. The user interface 430 further includes one or more input apparatuses 432, including a user interface component that facilitates inputting of a user, such as a keyboard, a mouse, a microphone, a touch display screen, a camera, or another input button and control.

The memory 450 may be a removable memory, a non-removable memory, or a combination thereof. An exemplary hardware device includes a solid-state memory, a hard disk drive, an optical disc driver, or the like. In some embodiments, the memory 450 includes one or more storage devices physically away from the processor 410.

The memory 450 includes a volatile memory or a non-volatile memory, or may include both a volatile memory and a non-volatile memory. The non-volatile memory may be a read only memory (ROM). The volatile memory may be a random access memory (RAM). The memory 450 described in this embodiment of the present disclosure is to include any other suitable type of memories.

In some embodiments, the memory 450 can store data to support various operations. Examples of the data include a program, a module, and a data structure, or a subset or a superset thereof, which are described below by using examples.

An operating system 451 includes a system program configured to process various basic system services and perform a hardware-related task, such as a framework layer, a core library layer, or a driver layer, and is configured to implement various basic services and process a hardware-based task.

A network communication module 452 is configured to reach another computing device through one or more (wired or wireless) network interfaces 420. Exemplary network interfaces 420 include: Bluetooth, wireless compatible certification (Wi-Fi), a universal serial bus (USB), and the like.

A display module 453 is configured to display information by using an output apparatus 431 (for example, a display screen or a loudspeaker) associated with one or more user interfaces 430 (for example, a user interface configured to operate a peripheral device and display content and information).

An input processing module 454 is configured to detect one or more user inputs or interactions from one of the one or more input apparatuses 432 and translate the detected input or interaction.

In some embodiments, a location set generation apparatus provided in this embodiment of the present disclosure may be implemented in a software manner. FIG. 2 shows a location set generation apparatus 455 stored in the memory 450. The location set generation apparatus may be software in a form of a program and a plug-in, and includes the following software modules: a source information determination module 4551, a set generation module 4552, a content display module 4553, a set update module 4554, and a theme determination module 4555. The modules are logical models, and may be combined in different manners or further divided based on a function to be implemented. The following describes functions of the modules.

In some other embodiments, the location set generation apparatus provided in this embodiment of the present disclosure may be implemented by using hardware. For example, the location set generation apparatus provided in this embodiment of the present disclosure may be a processor in a form of a hardware decoding processor, programmed to perform the location set generation method provided in the embodiments of the present disclosure. For example, the processor in the form of a hardware decoding processor may use one or more application specific integrated circuits (ASIC), digital signal processors (DSP), programmable logic devices (PLD), complex programmable logic devices (CPLD), field-programmable gate arrays (FPGA), or other electronic components.

In some embodiments, a terminal or a server (both are possible implementations of the electronic device) may implement, by running a computer program, the location set generation method provided in the embodiment of the present disclosure. For example, the computer program may be a native program or software module in the operating system. The computer program may be a native application (APP), that is, a program that can only be installed in the operating system for running, such as a map APP. The computer program may alternatively be an applet, that is, a program that only requires to be downloaded into a browser environment for running. The computer program may alternatively be an applet that can be embedded in any APP. In conclusion, the foregoing computer program may be an application program, a module, or a plug-in in any form.

The embodiments of the present disclosure may be applied to a location set generation scenario of map software, a navigation system, or the like. The following describes a location set generation method provided in the embodiments of the present disclosure. As described above, the electronic device implementing the location set generation method in the embodiments of the present disclosure may be a terminal, a server, or a combination thereof.

When the electronic device is implemented as a server, depending on a strong computing capability of the server, a more complex recognition model and a more comprehensive geographic information database can be used, to improve accuracy of extracting location information, thereby obtaining a more accurate location information set. When the electronic device is implemented as a terminal, offline generation of a location set can be implemented, that is, a process of generating the location information set does not depend on a network, does not consume traffic, and can further save computing resources. Therefore, in this embodiment of the present disclosure, the implementation of the electronic device may be selected according to an actual situation. For ease of describing the location set generation method provided in this embodiment of the present disclosure, an execution body of each operation below is the electronic device. Therefore, the execution body of each operation is not described repeatedly below.

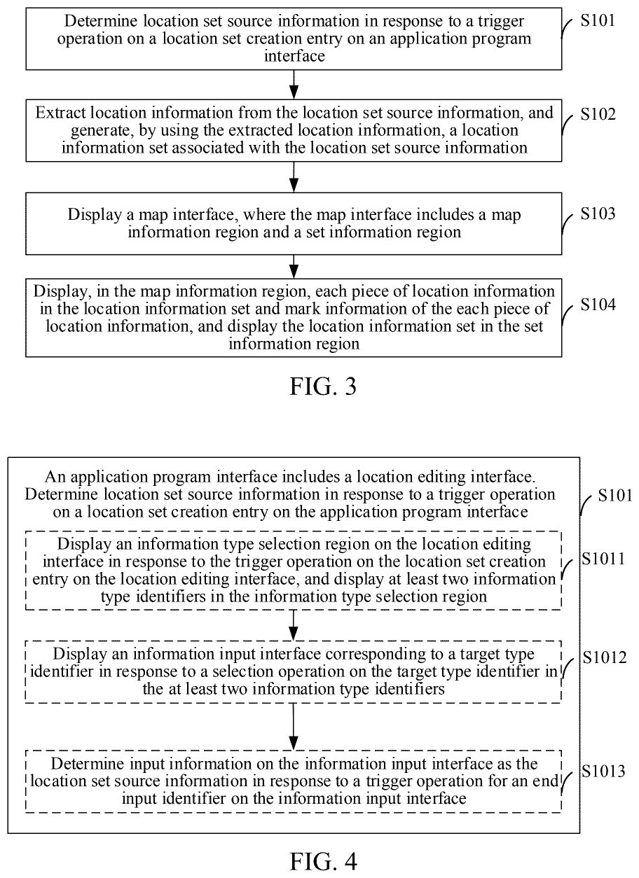

Referring to FIG. 3, FIG. 3 is a first schematic flowchart of a location set generation method according to an embodiment of the present disclosure, which is described with reference to operations shown in FIG. 3.

S101: Determine location set source information in response to a trigger operation on a location set creation entry on an application program interface.

This embodiment of the present disclosure is implemented in a scenario in which a location information set is generated based on information specified by a user. In this embodiment of the present disclosure, the location set creation entry is set on the application program interface, and a process of creating the location information set can be triggered by using the location set creation entry. When receiving a trigger operation on the location set creation entry, the electronic device responds to the trigger operation, and determines source information configured for performing a processing process of generating the location information set, that is, the location set source information.

The application program interface may be any interface that can load the location set creation entry, for example, a location editing interface in map software, or an information display interface of social software. This is not limited in this embodiment of the present disclosure.

The location set creation entry may be statically set at any position on the application program interface, for example, an upper right corner or a lower right corner of the application program interface. Regardless of whether the user performs an operation on the application program interface, the location set creation entry is displayed on the application program interface. Certainly, the location set creation entry may alternatively be dynamically displayed in response to an operation received on the application program interface. For example, after the electronic device receives an information selection operation and determines selected information, when the electronic device receives a function menu display operation on the information, the electronic device displays the location set creation entry on the application program interface in response to the function menu display operation.

The trigger operation on the location set creation entry may be an operation such as a click operation or a double-click operation, or may be an operation such as a slide operation or a long press operation. This is not limited in this embodiment of the present disclosure.

In this embodiment of the present disclosure, the location set source information is source information configured for parsing the location information set, that is, location information required to create the location information set has been implicitly included in the location set source information. The location set source information may be image information, for example, an image of a scenic spot list organized by a netizen. The location set source information may alternatively be text information, for example, scenic spot guide text. The location set source information may alternatively be audio information, for example, introduction to a region. The location set source information may be determined in any form according to an actual requirement. This is not limited in this embodiment of the present disclosure.

In this embodiment of the present disclosure, the electronic device provides a plurality of different manners for the user to specify the location set source information. Therefore, the electronic device can determine the location set source information in the plurality of different manners.

Referring to FIG. 4, FIG. 4 is a second schematic flowchart of a location set generation method according to an embodiment of the present disclosure. In some embodiments of the present disclosure, the application program interface includes a location editing interface. In this case, S101 in FIG. 3, to be specific, determining the location set source information in response to the trigger operation on the location set creation entry on the application program interface, may include the following processing process:

S1011: Display an information type selection region on the location editing interface in response to the trigger operation on the location set creation entry on the location editing interface, and display at least two information type identifiers in the information type selection region.

When the electronic device receives the trigger operation on the location set creation entry on the location editing interface, the electronic device displays the information type selection region on the location editing interface, generates at least two information type identifiers, and displays the generated information type identifiers in the information type selection region.

The at least two information type identifiers may include at least two of an image type identifier, a text type identifier, and an audio type identifier. Through a selection operation on the information type identifier, the electronic device determines which form of information is used as the location set source information.

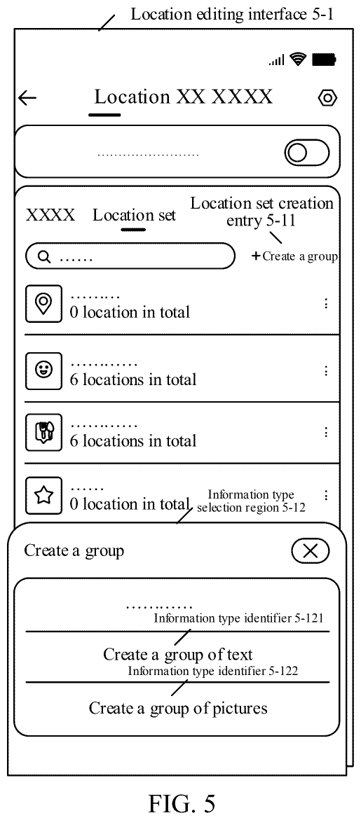

Exemplarily, FIG. 5 is a schematic diagram of a display process of an information type identifier according to an embodiment of the present disclosure. When the user clicks a location set creation entry 5-11 (displaying a character of “create a group”) on a location editing interface 5-1, the electronic device pops up an information type selection region 5-12 on the location editing interface 5-1, and displays an information type identifier 5-121 (displaying a character of “create a group of text”) and an information type identifier 5-122 (displaying a character of “create a group of pictures”) in the information type selection region 5-12, where the two information type identifiers are different.

S1012: Display an information input interface corresponding to a target type identifier in response to a selection operation on the target type identifier in the at least two information type identifiers.

When the electronic device receives the selection operation on any one of the at least two information type identifiers, the selected information type identifier is the target type identifier. After detecting the selection operation performed by the user on the target type identifier, the electronic device displays the information input interface corresponding to the target type identifier on the graphical interface, for the user to input information of a corresponding type.

When the target type identifier is an image type identifier, the information input interface is an interface through which image input may be performed, for example, an image selection interface. When the target type identifier is a text type identifier, the information input interface is an interface through which text input may be performed, for example, a text editing interface. When the target type identifier is an audio type identifier, the information input interface is an interface through which audio input may be performed, for example, an audio selection interface or an audio recording interface.

S1013: Determine input information on the information input interface as the location set source information in response to a trigger operation on an end input identifier on the information input interface.

After receiving the trigger operation on the end input identifier on the information input interface, the electronic device determines that information input has been completed, and directly determines the input information as the location set source information, for subsequent location information extraction.

In some embodiments of the present disclosure, the target type identifier includes a text type identifier, the information input interface includes a text editing interface, and correspondingly, the input information includes text information. In this case, S1013 in FIG. 4, that is, determining the input information on the information input interface as the location set source information in response to the trigger operation on the end input identifier on the information input interface, may be implemented by using the following processing: determining the text information on the text editing interface as the location set source information in response to the trigger operation on the end input identifier on the text editing interface.

The text information on the text editing interface may be entered by the user through a keyboard, or may be pasted by the user from a clipboard (that is, the user may directly paste guide text on a network to the text editing interface). This is not limited in this embodiment of the present disclosure.

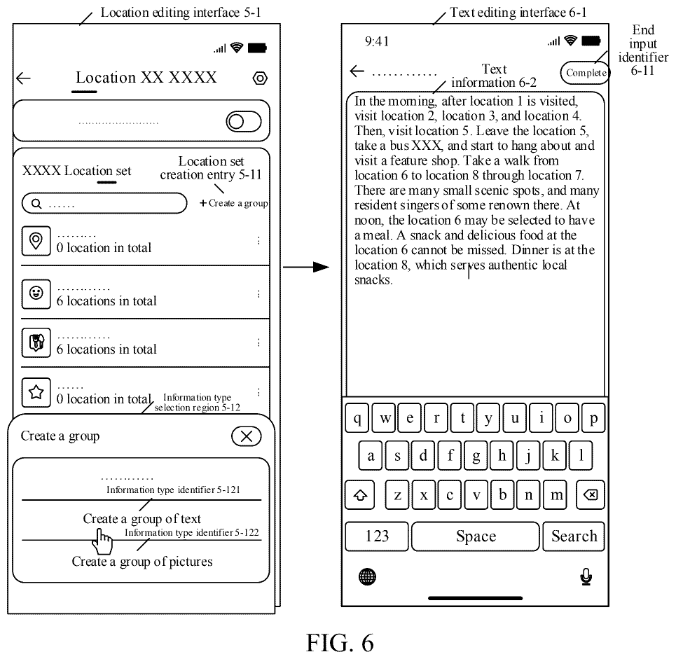

Exemplarily, based on FIG. 5, referring to FIG. 6, FIG. 6 is a schematic diagram of a process of determining text information as location set source information according to an embodiment of the present disclosure. After the user clicks the information type identifier 5-121, the electronic device displays a text editing interface 6-1 on the graphical interface, for the user to input text information. When detecting that the user clicks an end input identifier 6-11 (displaying a character of “finish”) on the text editing interface 6-1, the electronic device uses text information 6-2 entered by the user on the text editing interface 6-1 as the location set source information, and subsequently extracts location information from the text information.

In some other embodiments of the present disclosure, the target type identifier includes an image type identifier, the information input interface includes an image upload interface, and the input information includes image information. In this case, S1013 in FIG. 4, that is, determining the input information on the information input interface as the location set source information in response to the trigger operation on the end input identifier on the information input interface, may be implemented by using the following processing: determining image information on the image upload interface as the location set source information in response to the trigger operation on the end input identifier on the image upload interface.

The image information on the image upload interface may be selected by the user from a plurality of images (for example, the user may enter an album by using a “select” button on the image upload interface, and then select an image from the album), or may be pasted by the user from a clipboard to the image upload interface. This is not limited in this embodiment of the present disclosure.

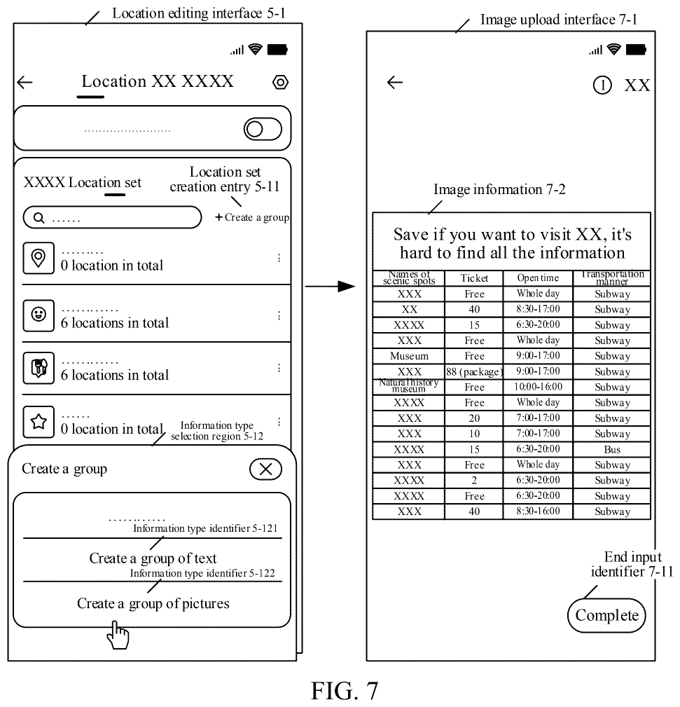

Exemplarily, based on FIG. 5, referring to FIG. 7, FIG. 7 is a schematic diagram of a process of determining image information as location set source information according to an embodiment of the present disclosure. After the user clicks the information type identifier 5-122, the electronic device displays an image upload interface 7-1 on the graphical interface, for the user to upload image information. When detecting that the user clicks an end input identifier 7-11 (displaying a character of “finish”) on the image upload interface 7-1, the electronic device uses image information 7-2 entered by the user on the image upload interface 7-1 as the location set source information, and subsequently extracts location information from the image information.

The electronic device may provide a plurality of different information type selection identifiers on the location editing interface for the user to select, thereby making forms of the location set source information more diversified and improving generation efficiency of a location information set.

The location editing interface may be a functional interface in application software such as map software or travel guide software. That is, the location editing interface may appear when the user triggers a location editing function in the application software. The location editing interface may alternatively be a main interface of some application software such as a main interface of location set software or a main interface of memo software, so that the location editing interface may be displayed when the user starts the application software.

That is, in some embodiments of the present disclosure, before the displaying an information type selection region on the location editing interface in response to the trigger operation on the location set creation entry on the location editing interface, and displaying at least two information type identifiers in the information type selection region, to be specific, before S1011, the method may further include: displaying the location editing interface in response to a trigger operation on a set editing identifier on a map interface, and displaying the location set creation entry on the location editing interface.

That is, the electronic device first displays the map interface on the graphical interface of the electronic device, and then when receiving the trigger operation on the set editing identifier on the map interface, the electronic device displays the location editing interface and displays the location set creation entry. Then, after detecting that the user performs a trigger operation on the location set creation entry and completes generation of the location information set, the electronic device returns to display of the map interface, so as to display the location information and the location information set on the map interface.

In some embodiments of the present disclosure, the application program interface includes an information display interface. In this case, S101 in FIG. 3, to be specific, determining the location set source information in response to the trigger operation on the location set creation entry on the application program interface, may include the following processing: determining display information on the information display interface as the location set source information in response to the trigger operation on the location set creation entry on the information display interface.

That is, when the application program interface is the information display interface, if the user performs a trigger operation on the location set creation entry, the electronic device directly determines information that is being displayed on the information display interface, that is, the display information, as the location set source information. In this way, information may be first selected, and then a process of creating the location information set is triggered.

In some embodiments of the present disclosure, before the determining display information on the information display interface as the location set source information in response to the trigger operation on the location set creation entry on the information display interface, the method may further include the following processing: displaying at least one candidate application identifier on the information display interface in response to an editing operation on the display information on the information display interface; and displaying, on the information display interface, at least one editing function entry corresponding to a map application identifier in response to a selection operation on the map application identifier in the at least one candidate application identifier, where the at least one editing function identifier includes the location set creation entry.

When detecting that an editing function is triggered for the display information, the electronic device displays, on the display interface, a candidate application identifier of a candidate application that can edit the display information, for the user to select. When a selection operation performed by the user on the map application identifier is detected, editing function entries that can edit the display information in the map application identifier are further displayed. These editing function entries include the location set creation entry, so that the electronic device can display the location set creation entry. The information display interface may be an interface of any application software, and the display information may be text information, image information, video information, or the like. This is not specifically limited in this embodiment of the present disclosure. The editing operation may be an operation of long pressing to trigger editing, or may be an operation of clicking a menu and selecting an editing option.

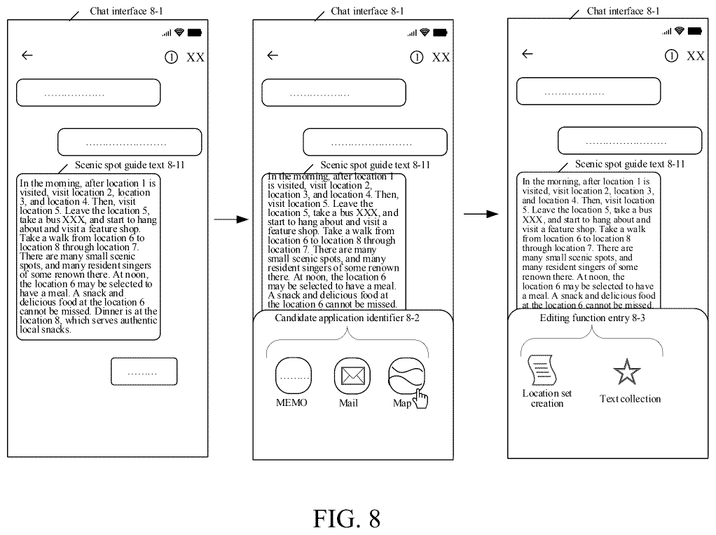

Exemplarily, FIG. 8 is a schematic diagram of display of a location creation set entry according to an embodiment of the present disclosure. Referring to FIG. 8, the information display interface is a chat interface 8-1 of social software. The chat interface 8-1 displays scenic spot guide text 8-11 (referred to as display information) sent by a friend of the user to the user. When detecting that the user performs a long press operation on the scenic spot guide text 8-11, the electronic device displays three candidate application identifiers 8-2 that can edit the scenic spot guide text 8-11, such as a memo application identifier, an email application identifier, and a map application identifier. When detecting that the user performs a selection operation on the map application identifier, the electronic device displays different editing function entries 8-3 that can be provided by the map application identifier for the scenic spot guide text 8-11, that is, a location set creation entry and a text collection entry. In this way, the electronic device can provide the location set creation entry to the user.

S102: Extract location information from the location set source information, and generate, by using the extracted location information, a location information set associated with the location set source information.

After obtaining the location set source information, the electronic device parses the location set source information, to extract the location information from the location set source information, and performs set generation on the extracted location information, to obtain a corresponding location information set. Because the location information is extracted from the location set source information, the extracted location information has an association relationship with the location set source information. In this way, the obtained location information set also has an association relationship with the location set source information, to ensure that the obtained location information set matches the location set source information.

A manner of extracting the location information by the electronic device for the location set source information may be associated with an information form of the location set source information.

In some embodiments of the present disclosure, the location set source information includes image information. In this case, S102 in FIG. 3, to be specific, extracting the location information from the location set source information, may be implemented by using the following processing: performing text extraction on the image information, to obtain extracted text; and identifying a plurality of candidate locations from the extracted text. The plurality of candidate locations are screened to complete location information extraction, to obtain the location information.

That is, when the location set source information is image information, the electronic device first extracts text included in the image information, to obtain extracted text, and then identifies locations from the extracted text, to obtain a plurality of candidate locations. Then, the electronic device screens the plurality of candidate locations, to extract truly available location information from the plurality of candidate locations, thereby completing a location information extraction process of the location set source information.

The electronic device may perform text extraction on the image information by using an OCR technology, or may perform text extraction on the image information by using a deep learning technology. The electronic device may perform word segmentation on the extracted text, match a word segmentation result with a location name entity word library, and use a matched location as a candidate location. The electronic device may alternatively perform semantic analysis on the extracted text by using the deep learning technology, to obtain a location mentioned in semantic meaning of the text, and use the location as a candidate location.

In some embodiments, the screening the plurality of candidate locations to obtain the location information may be implemented by using the following processing: screening candidate locations that are in a same geographical range in the plurality of candidate locations, to obtain the location information.

That is, the electronic device may screen candidate locations located in the same geographical range as final location information, to complete location information extraction. In this way, the obtained location information is located in the same geographical range, so that the obtained location information set is more targeted. The geographical range may be set according to an actual requirement, for example, set to a province, a city, or a district. This is not limited in this embodiment of the present disclosure.

In some other embodiments, the screening the plurality of candidate locations to obtain the location information may be implemented by using the following processing: screening a candidate location whose confidence is higher than a confidence threshold in the plurality of candidate locations, to obtain the location information.

That is, the electronic device may screen a candidate location having a highest credibility from the plurality of candidate locations as the final location information. In this way, the obtained location information is more reliable.

In some other embodiments, the location set source information includes text information, and S102 in FIG. 3, that is, extracting the location information from the location set source information, and generating, by using the extracted location information, the location information set associated with the location set source information, may alternatively be implemented by using the following processing: performing the word segmentation on the text information, to obtain a plurality of word segmentation results; and extracting a word segmentation result that hits a location name entity word library in the plurality of word segmentation results, to obtain the location information.

That is, when the location set source information is text information, the electronic device may directly perform word segmentation on the text information, and match word segmentation results with the location name entity word library, where a word segmentation result matching the location name entity word library is the location information, to complete location information extraction.

Certainly, for some cases in which the location set source information is information in another form, for example, when the location set source information is audio information or video information, the electronic device can convert the audio information or the video information into text information (for example, conversion into the text information is implemented in a manner such as speech recognition or video semantic understanding), and then implement location information extraction on the audio information or the video information according to a process of processing the text information.

S103: Display a map interface, where the map interface includes a map information region and a set information region.

The electronic device renders the map interface, and displays the map interface on a graphical interface of the electronic device. The map interface includes the map information region configured for displaying detailed map data, to be specific, information such as a road name or a location name in the map data is displayed in the map information region. The map interface further includes the set information region configured for displaying the location information set, so that information associated with the location information set is displayed in the set information region.

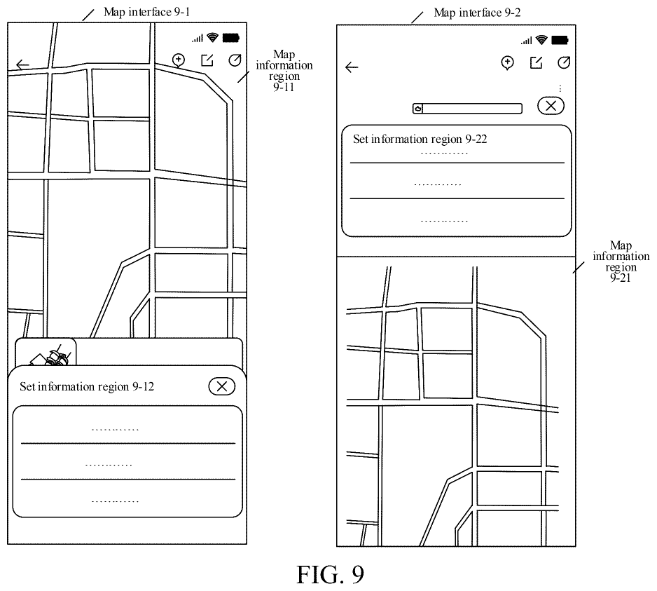

Size, positions, and even layers of the map information region and the set information region on the map interface may be set according to an actual situation. Exemplarily, FIG. 9 is a schematic diagram of laying out a map interface in two different manners according to an embodiment of the present disclosure. On a map interface 9-1, a map information region 9-11 may be located on a bottom layer of the map interface, where a size of the map information region may be the same as a size of the map interface, and a set information region 9-12 may be displayed on an upper layer of the map information region in a form of a floating window.

However, on a map interface 9-2, a map information region 9-21 may be located in a lower half part of the map interface, and a set information region 9-22 may be located in an upper half part of the map interface, where the map information region and the set information region each occupy a half area of the map interface.

In addition to performing S102 and S103 in the foregoing sequence, the electronic device may alternatively perform S102 and S103 in another sequence. For example, the electronic device may first perform S103 and then perform S102, or synchronously perform S102 and S103. This is not limited in this embodiment of the present disclosure.

S104: Display, in the map information region, a plurality of locations in the location information set and marks corresponding to the plurality of locations, and display the location information set in the set information region.

After displaying the map interface on the graphical interface, the electronic device displays, in the map information region, map data of the location information in the location information set (i.e., displays the plurality of locations in the location information set), adds the mark information for each piece of location information to the displayed map data (i.e., adds marks to the plurality of locations, each mark corresponding to one of the locations), and displays, in the map information region, the each piece of location information and the mark information of the each piece of location information (i.e., displays the locations and the corresponding marks), so that the location information is more conspicuous. In addition, the electronic device displays the determined location set information in the set information region, for the user to understand a specific situation of the location information set.

The mark information added by the electronic device for the each piece of location information may be set according to an actual requirement, for example, may be set to a star mark, or may be set to a highlight mark. This is not limited in this embodiment of the present disclosure.

In addition to the location information extracted from the location set source information, the location information set may further include basic information of the location information, such as a netizen recommendation level, a popularity index, and an open time. Therefore, by displaying the location information set, the electronic device not only can provide the location information related to the location set source information to the user, but also can provide the basic information of the location information to the user, thereby improving richness of information included in the map information set, and improving information spreading efficiency.

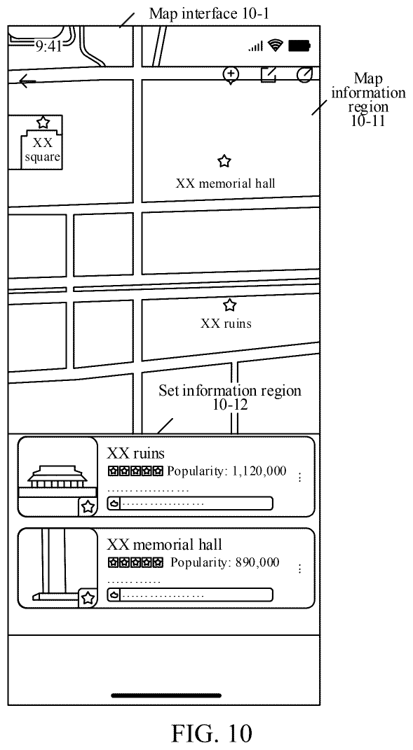

Exemplarily, FIG. 10 is a schematic diagram of display of location information and a location information set according to an embodiment of the present disclosure. Referring to FIG. 10, map data of a location information set, for example, map data of XX ruins, an XX memorial hall, and an XX square, is displayed in a map information region 10-11 of a map interface 10-1, and star marks are added to the location information. Specific content of the location information set is displayed in a set information region 10-12 of the map interface 10-1, that is, the location information of the XX ruins, the XX memorial hall, and the XX square (not shown in the figure) included in the location information set, and the basic information of the location information.

Compared with a problem of low efficiency in generating a location information set since complex manual operations are required to generate the location information set in the related art, in this embodiment of the present disclosure, after receiving the trigger operation on the location set creation entry, the electronic device first determines the location set source information configured for extracting location information, and then automatically extracts the location information from the location set source information, and uses the extracted location information to form the location information set, thereby replacing a manual information input process of the user with an automatic information extraction process, and generating the location information set with one click. Therefore, the operation required when creating the location information set is simplified, and the efficiency of generating a new location set is improved.

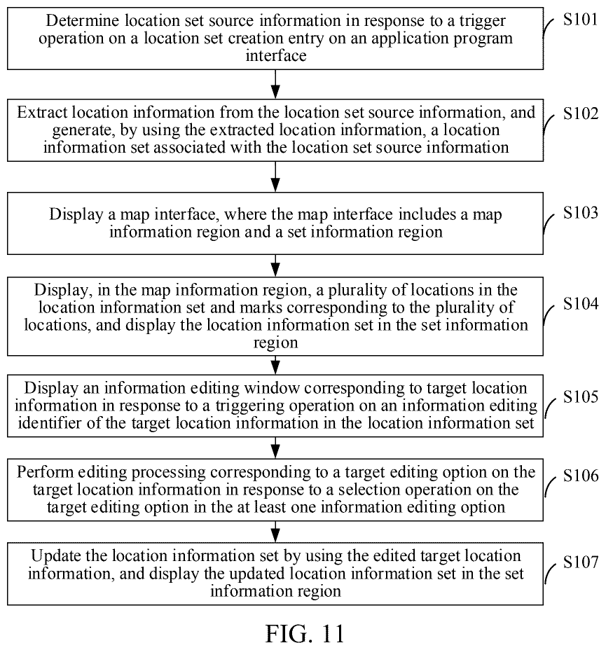

Based on FIG. 3, referring to FIG. 11, FIG. 11 is a third schematic flowchart of a location set generation method according to an embodiment of the present disclosure. In some embodiments of the present disclosure, after S104 in FIG. 3, that is, after displaying, in the map information region, the each piece of location information in the location information set and the mark information of the each piece of location information, and displaying the location information set in the set information region, the method may further include the following processing:

S105: Display an information editing window corresponding to target location information in response to a triggering operation on an information editing identifier of the target location information in the location information set.

Each piece of location information in the location information set includes a corresponding information editing identifier, to trigger an information editing process of the each piece of location information. When receiving a trigger operation on the information editing identifier of any one piece of location information in the location information set, the electronic device determines the location information as the target location information in response to the trigger operation, and pops up an information editing window corresponding to the target location information on the map interface.

The information editing window includes at least one information editing option, and each information editing option is configured for triggering editing processing on the target location information. For example, the information editing window may include a remark setting option, to trigger remark setting processing on the target location information. The information editing window may include a custom icon option, to trigger custom icon setting for the target location information. The information editing window may further include a location deletion option, so that the user deletes the target location information from the location information set.

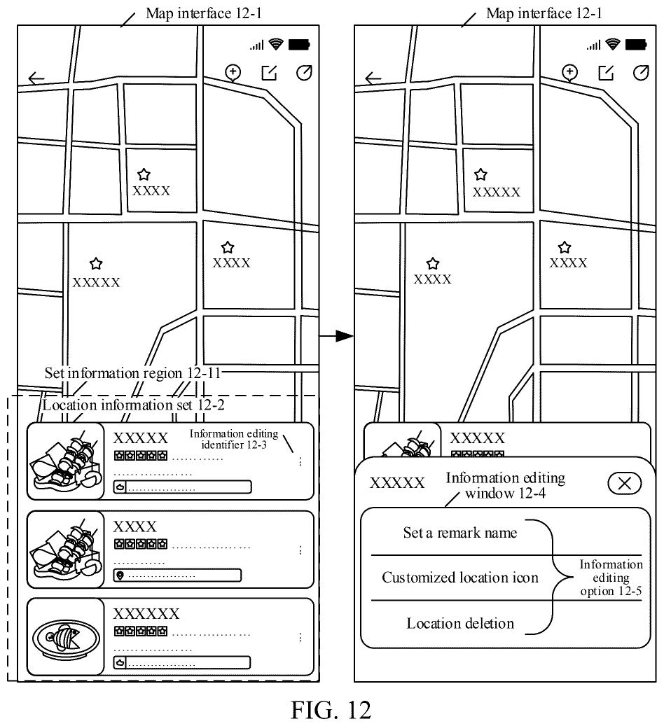

Exemplarily, FIG. 12 is a schematic diagram of display of an information editing window according to an embodiment of the present disclosure. In a set information region 12-11 of a map interface 12-1, a location information set 12-2 is displayed, where each piece of location information respectively includes an information editing identifier 12-3. When the user clicks the information editing identifier 12-3 of one piece of location information, the electronic device will pop up an information editing window 12-4 corresponding to the location information on the map interface 12-1. In the information editing window 12-4, there are three information editing options 12-5, including setting a remark name, customizing a location icon, and deleting a location.

S106: Perform editing processing corresponding to a target editing option on the target location information in response to a selection operation on the target editing option in the at least one information editing option

When receiving the selection operation on the target editing option in the at least one information editing option, the electronic device applies, for the target location information, editing processing corresponding to the target editing option. For example, when detecting that the user performs a selection operation on the location deletion option, the electronic device deletes the target location information from the location information set. When detecting that the user performs a selection operation on the remark setting option, the electronic device determines information input by the user as a remark name of the target location information.

The selection operation may be an operation such as a click operation or a double-click operation, or may be an operation such as a long press operation or a slide operation. This is not limited in this embodiment of the present disclosure.

S107: Update the location information set by using the edited target location information, and display the updated location information set in the set information region.

After completing editing processing on the target location information, the electronic device can obtain edited target location information, and update the location information set by using the edited target location information. For example, a name of the target location information in the location information set is changed to a user-defined remark name, or the target location information is removed from the location information set, to obtain the updated location information set. Then, the electronic device displays the updated location information set in the set information region, to provide the latest location information set to the user.

In this embodiment of the present disclosure, the electronic device can further update the location information set in response to an operation of the user, that is, can implement personalized editing on the obtained location information set by the user, so that the location information set can better conform to a use habit of the user, and an adaptation degree between the location information set and the user is improved.

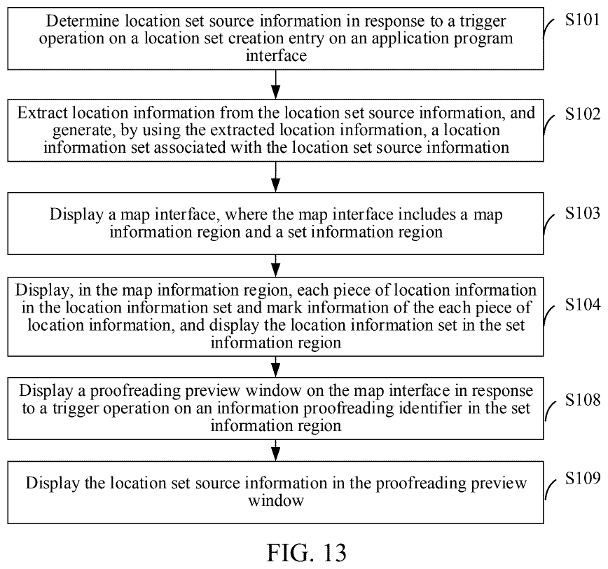

Based on FIG. 3, referring to FIG. 13, FIG. 13 is a fourth schematic flowchart of a location set generation method according to an embodiment of the present disclosure. In some embodiments of the present disclosure, after S104 in FIG. 3, that is, after displaying, in the map information region, the each piece of location information in the location information set and the mark information of the each piece of location information, and displaying the location information set in the set information region, the method may further include the following processing:

S108: Display a proofreading preview window on the map interface in response to a trigger operation on an information proofreading identifier in the set information region.

In this embodiment of the present disclosure, the electronic device sets the information proofreading identifier in the set information region, to trigger a proofreading function for the location information set. When receiving the trigger operation on the information proofreading identifier, the electronic device renders the proofreading preview window, and displays the proofreading preview window on the map interface.

S109: Display the location set source information in the proofreading preview window.

Then, the electronic device displays the original location set source information in the proofreading preview window, to perform comparison verification on the location information set and the location set source information, to perform operations such as checking for omissions and filling gaps for the location information set, thereby improving completeness and accuracy of the location information set.

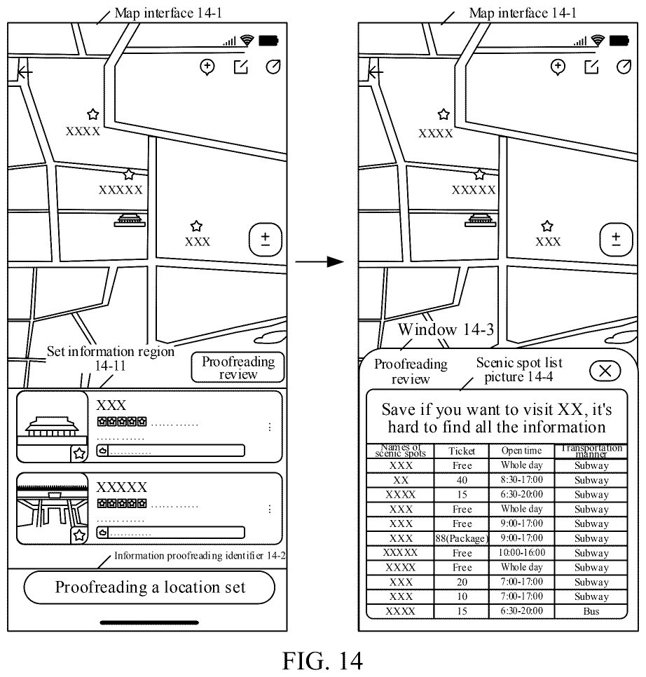

Exemplarily, FIG. 14 is a schematic diagram of a proofreading preview window according to an embodiment of the present disclosure. Referring to FIG. 14, an information proofreading identifier 14-2 (displaying a character of “proofreading a location set”) is set in a set information region 14-11 of a map interface 14-1. After the user clicks the information proofreading identifier 14-2, a proofreading preview window 14-3 pops up on the map interface 14-1, and the original location set source information of the user, such as a scenic spot list picture 14-4, is displayed in the proofreading preview window 14-3, for the user to manually perform comparison verification on the location information set.

In some embodiments of the present disclosure, after S104 in FIG. 3, that is, after displaying, in the map information region, the each piece of location information in the location information set and the mark information of the each piece of location information, and displaying the location information set in the set information region, the method may further include the following processing: displaying a theme input region corresponding to the location information set in response to a trigger operation on a theme editing identifier that is on the map interface and that corresponds to the location information set; and determining input information obtained from the theme input region as theme information of the location information set, and correspondingly storing the theme information and the location information set.

That is, after displaying the location information and the location set information, the electronic device may further display a theme editing identifier corresponding to the location information set on the map interface, to provide a theme editing function for the location information set. When receiving the trigger operation on the theme editing identifier, the electronic device displays the theme input region on the map interface, for the user to input information. Then, the electronic device obtains the input information in the theme input region, and uses the obtained input information as the theme information of the location information set for corresponding storage. In this way, personalized theme setting for the location information set can be completed.

In addition to determining the theme information for the location information set according to the input information of the user, the electronic device may also recombine, for example, merge, compare, and deduplicate a plurality of location information sets including different theme information, so that different location information sets may be regenerated by using the plurality of location information sets including different theme information.

In some embodiments of the present disclosure, after the theme information and the location information set are correspondingly stored, the method may further include the following processing: obtaining a plurality of location information sets corresponding to a plurality of pieces of theme information in response to a trigger operation on a theme integration identifier on the map interface; performing set recombination on the plurality of location information sets, to obtain an integrated information set of the plurality of location information sets; and displaying the integrated information set in the set information region of the map interface.

That is, the user may trigger integration processing on location information sets including different theme information by using the theme integration identifier. In this case, the electronic device may obtain a plurality of location information sets in a one-to-one correspondence with the plurality of pieces of theme information, and merges the plurality of location information sets into one location information set according to a rule specified by the user or a preset rule, where the location information set is the integrated information set. Finally, the electronic device displays the obtained integrated information set in the set information region, thereby providing more complete location information to the user.

Performing set recombination on the plurality of location information sets may refer to merging different location information sets, so that the integrated information set is a union set of the plurality of location information sets. In this way, the integrated information set may be more complete. Performing set recombination on the plurality of location information sets may alternatively refer to taking an intersection of the plurality of location information sets, so that the integrated information set is an intersection of the plurality of location information sets. In this way, the integrated information set is more simplified. Performing set recombination on the plurality of location information sets may alternatively refer to performing deduplication processing on the plurality of location information sets. For example, location information duplicated with that in another location information set is removed from one location information set, so that the obtained integrated information set is more personalized.

After finishing display of the location information set, the electronic device may further provide the user with different operations for the location information set by using different operation entries of the location information set. Therefore, the user performs different operations on the location information set based on a requirement of the user, so that the location information set better meets the requirement of the user.

The following describes an exemplary application of an embodiment of the present disclosure in an actual application scenario.

This embodiment of the present disclosure is implemented in a scenario in which a location set (referred to as a location information set) is rapidly generated based on information provided by the user.

After the user opens map software and selects to create a location set group, in this embodiment of the present disclosure, the user may be prompted in a form of a pop-up window (referred to as an information type selection region), and the location set may be generated in two different manners by inputting text or uploading a picture. For the form of the pop-up window, reference may be made to FIG. 5.

After the user clicks to input text or upload a picture to upload information, in this embodiment of the present disclosure, the created location set may be displayed to the user in a form of a drawing, and the user is supported to perform an operation on a single location, such as remark setting or location deletion. For an interface change during this process, reference may be made to FIG. 12.

In this embodiment of the present disclosure, the user is further enabled to manually performs comparison verification on a location set that has been generated and original graphic and textual information. For an interface change during this process, reference may be made to FIG. 14.

In addition, in this embodiment of the present disclosure, theme setting may further be performed for the location set, that is, a location set that is obtained after a picture or text specified by the user is recognized may be stored as a theme (referred to as theme information). The user may establish a plurality of different themes, and may perform operations such as merging, taking an intersection, and deduplication on location sets under the plurality of different themes. For example, for a location set whose theme is “a list of restaurants recommended by A” and a location set (referred to as an integrated information set) whose theme is “a list of restaurants recommended by B”, in this embodiment of the present disclosure, a union set may be obtained for the two location sets, to obtain a more complete location set. An intersection may alternatively be taken for the two location sets, to reserve an overlapped location set. The location set is a list of restaurants recommended by both A and B, and the location set is more accurate. Deduplication processing may alternatively be performed on the two location sets, for example, to obtain “a list of restaurants that A has visited but B has not visited”, or “a list of restaurants that B has visited but A has not visited”. This is not limited in this embodiment of the present disclosure.

The following describes a generation process of a location set in this embodiment of the present disclosure. In this embodiment of the present disclosure, the location set is generated by cooperative interaction between a terminal and a server (that is, the electronic device is implemented as a device cluster formed by the terminal and the server).

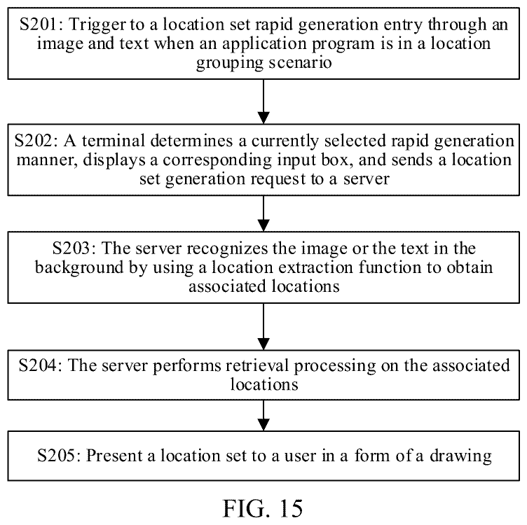

FIG. 15 is a first processing flowchart of generating a location set according to an embodiment of the present disclosure. Referring to FIG. 15, the process includes the following operations:

S201: Trigger to display a location set rapid generation entry through an image and text (referred to as a location set creation entry) when an application program is in a location grouping scenario (referred to as a location editing interface).

S202: A terminal determines a currently selected rapid generation manner (referred to as a target type identifier), displays a corresponding input box (referred to as an information input interface), and transmits a location set generation request to a server.

S203: The server recognizes the image or text in the background by using a location information extraction function, to obtain associated locations (referred to as candidate locations).

In this case, the server may directly extract locations associated with a map database from the text, or may first extract text in the image through an OCR recognition capability, and then extract location information associated with a map database from the text.

S204: The server performs retrieval processing on the associated locations, to obtain locations (referred to as location information) that finally form a set.

In this case, the server may perform retrieval processing by using a geographical range as a recall condition. That is, locations in a same geographical range, for example, locations in a same province, city, or district, are recalled to obtain a location set, or locations having highest confidence are recalled to obtain a location set.

S205: Display the location set to a user in a form of a drawing.

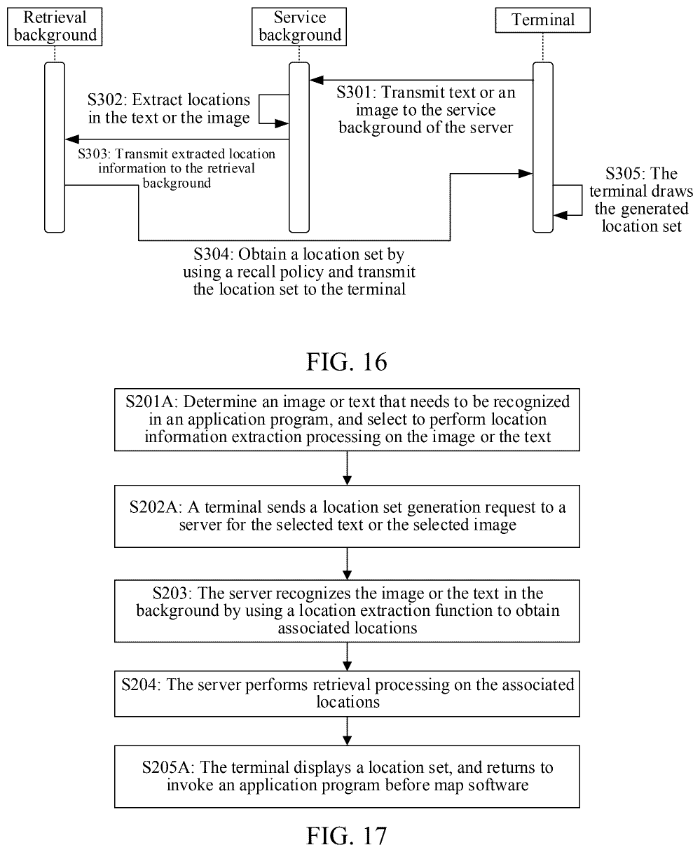

Referring to FIG. 16, FIG. 16 is a flowchart of interaction between a server and a terminal in a location set generation process according to an embodiment of the present disclosure. The interaction process includes the following operations.

S301: A terminal transmits text or an image to a service background of a server.

S302: The service background extracts locations in the text or the image.

S303: The service background transmits the extracted locations to a retrieval background in the server.

S304: The retrieval background obtains a location set by using a recall policy, and transmits the location set to the terminal.

S305: The terminal draws the generated location set, to display the location set to the user.

An implementation process of operation S301 to operation S305 is similar to an implementation process of operation S101 to operation S104 in another embodiment. For implementations of operation S301 to operation S305, reference may be made to the implementation process of operation S101 to operation S104.

Certainly, S201, S202, and S205 in the foregoing process may alternatively be replaced with other processing. Exemplarily, FIG. 17 is a second processing flowchart of generating a location set according to an embodiment of the present disclosure. The process includes the following operations.

S201A: Determine an image or text that needs to be recognized in an application program, and select to perform location information extraction processing on the image or the text.

That is, the terminal may first determine, on an interface (referred to as an information display interface) of another application program, for example, a chat interface of social software or a web browsing interface, an image or text that needs to be recognized, and then select to perform location information extraction processing on the image or the text by using map software. In this process, after the image or the text is selected, map software is selected from an available application menu (referred to as a candidate application identifier) appearing for the image or the text for processing, and selection is performed on different functions (referred to as editing function entries) displayed by the map software for location information set extraction processing. Certainly, the location set may alternatively be generated by selecting a point of interest navigation function in the map software.

S202A: The terminal sends a location set generation request to the server for the selected text or the selected image.

S203: The server recognizes the image or the text in the background by using a location information extraction function, to obtain associated locations.

S204: The server performs retrieval processing on the associated locations, to obtain locations that finally form a set.

S205A: The terminal displays the location set, and returns to invoke an application program before the map software.

In this way, it may be convenient for the user to continue to perform location set generation processing on a next image or next text.

In this embodiment of the present disclosure, related data such as location information, location set source information, and a location information set is involved. When the embodiments of the present disclosure are applied to a specific product or technology, user permission or consent needs to be obtained, and collection, use, and processing of the related data need to comply with related laws and regulations and standards of related countries and regions. In addition, in the embodiments of the present disclosure, the related data grabbing technical solution is implemented. When the foregoing embodiments of the present disclosure are applied to a specific product or technology, collection, use, and a processing process of the related data should comply with laws and regulations of related countries, satisfy principles of validity, justice, and necessity, do not involve obtaining data types that are prohibited or restricted by laws and regulations, and do not hinder normal running of related applications.

The following continues to describe an exemplary structure of the location set creation apparatus 455 provided in the embodiments of the present disclosure implemented as a software module. In some embodiments, as shown in FIG. 2, software modules in the location set creation apparatus 455 stored in the memory 450 may include:
a source information determination module 4551, configured to determine location set source information in response to a trigger operation on a location set creation entry on an application program interface;
a set generation module 4552, configured to extract location information from the location set source information, and generate, by using the extracted location information, a location information set associated with the location set source information; and
a content display module 4553, configured to: display a map interface, where the map interface includes a map information region and a set information region, and display, in the map information region, a plurality of locations in the location information set and marks corresponding to the plurality of locations, and display the location information set in the set information region.

In some embodiments of the present disclosure, the application program interface includes a location editing interface; and the source information determination module 4551 is further configured to: display an information type selection region on the location editing interface in response to the trigger operation on the location set creation entry on the location editing interface, and display at least two information type identifiers in the information type selection region; display an information input interface corresponding to a target type identifier in response to a selection operation on the target type identifier in the at least two information type identifiers; and determine input information on the information input interface as the location set source information in response to a trigger operation on an end input identifier on the information input interface.

In some embodiments of the present disclosure, the target type identifier includes a text type identifier, the information input interface includes a text editing interface, and the input information includes text information; and the source information determination module 4551 is further configured to determine the text information on the text editing interface as the location set source information in response to a trigger operation on an end input identifier on the text editing interface.

In some embodiments of the present disclosure, the target type identifier includes an image type identifier, the information input interface includes an image upload interface, and the input information includes image information; and the source information determination module 4551 is further configured to determine the image information on the image upload interface as the location set source information in response to a trigger operation on an end input identifier on the image upload interface.

In some embodiments of the present disclosure, the content display module 4553 is further configured to: display the location editing interface in response to a trigger operation on a set editing identifier on the map interface, and display the location set creation entry on the location editing interface.

In some embodiments of the present disclosure, the source information determination module 4551 is further configured to determine display information on the information display interface as the location set source information in response to the trigger operation on the location set creation entry on the information display interface.

In some embodiments of the present disclosure, the content display module 4553 is further configured to: display at least one candidate application identifier on the information display interface in response to an editing operation on the display information on the information display interface; and display, on the information display interface, at least one editing function entry corresponding to a map application identifier in response to a selection operation on the map application identifier in the at least one candidate application identifier, where the at least one editing function identifier includes the location set creation entry.

In some embodiments of the present disclosure, the location set generation apparatus 455 further includes a set update module 4554; the content display module 4553 is further configured to display an information editing window corresponding to target location information in response to a trigger operation on an information editing identifier of target location information in the location information set, where the information editing window includes at least one information editing option; and

the set update module 4554 is configured to: perform editing processing corresponding to a target editing option on the target location information in response to a selection operation on the target editing option in the at least one information editing option; and update the location information set by using the edited target location information, and display the updated location information set in the set information region.

In some embodiments of the present disclosure, the content display module 4553 is further configured to: display a proofreading preview window on the map interface in response to a trigger operation on an information proofreading identifier in the set information region; and display the location set source information in the proofreading preview window.

In some embodiments of the present disclosure, the location set generation apparatus 455 further includes a theme determination module 4555;

the content display module 4553 is further configured to display a theme input region corresponding to the location information set in response to a trigger operation on a theme editing identifier corresponding to the location information set on the map interface; and

the theme determination module 4555 is configured to determine input information obtained from the theme input region as theme information of the location information set, and correspondingly store the theme information and the location information set.

In some embodiments of the present disclosure, the set update module 4554 is further configured to: obtain a plurality of location information sets corresponding to a plurality of pieces of theme information in response to a trigger operation on a theme integration identifier on the map interface; and perform set recombination on the plurality of location information sets, to obtain an integrated information set of the plurality of location information sets; and

the content display module 4553 is further configured to display the integrated information set in the set information region of the map interface.

In some embodiments of the present disclosure, the set generation module 4552 is further configured to: perform text extraction on the image information to obtain extracted text, and identify a plurality of candidate locations from the extracted text; and screen the plurality of candidate locations to obtain the location information, to complete extraction of the location information.

In some embodiments of the present disclosure, the set generation module 4552 is further configured to: screen candidate locations that are in a same geographical range in the plurality of candidate locations, to obtain the location information; or screen a candidate location whose confidence is higher than a confidence threshold in the plurality of candidate locations, to obtain the location information.

An embodiment of the present disclosure provides a computer program product, where the computer program product includes a computer program or computer-executable instructions, and the computer program or the computer-executable instructions are stored in a computer-readable storage medium. A processor of an electronic device reads the computer-executable instructions from the computer-readable storage medium and executes the computer-executable instructions to cause the electronic device to perform the foregoing location set generation method according to the embodiments of the present disclosure.

An embodiment of the present disclosure provides a computer-readable storage medium storing computer-executable instructions, having the computer-executable instructions stored therein. When the computer-executable instructions are executed by a processor, the processor is caused to perform the location set generation method according to the embodiments of the present disclosure, such as the location set generation method shown in FIG. 3.

In some embodiments, the computer-readable storage medium may be a memory such as a ferromagnetic random access memory (FRAM), a read only memory (ROM), a programmable read only memory (PROM), an erasable programmable read only memory (EPROM), an electrically erasable programmable read-only memory (EEPROM), a flash memory, a magnetic surface memory, an optical disk, or a compact disc read only memory (CD-ROM); or may be any device including one of or any combination of the foregoing memories.

In some embodiments, the computer-executable instructions may be written in any form of programming language (including a compiled or interpreted language, or a declarative or procedural language) by using the form of a program, software, a software module, a script, or code, and may be deployed in any form, including being deployed as an independent program or being deployed as a module, a component, a subroutine, or another unit suitable for use in a computing environment.

In an example, the computer-executable instructions may, but do not necessarily, correspond to a file in a file system, and may be stored in a part of a file that saves another program or other data, for example, be stored in one or more scripts in a hyper text markup language (HTML) file, stored in a file that is specially configured for a program in discussion, or stored in a plurality of collaborative files (for example, be stored in files of one or modules, subprograms, or code parts).

In an example, the computer-executable instructions may be deployed to be executed on an electronic device, or deployed to be executed on a plurality of electronic devices at the same location, or deployed to be executed on a plurality of electronic devices that are distributed in a plurality of locations and interconnected by using a communication network.

In conclusion, according to the embodiments of the present disclosure, after a user performs a trigger operation on a location set creation entry, an electronic device first determines location set source information which is specified by the user and is configured for extracting location information, then automatically extracts location information from the location set source information, and uses the extracted location information to form a location information set, to replace a manual information input process of the user with an automatic information extraction process, and complete generation of the location information set with one click. Therefore, operations required for creating the location information set is simplified, thereby improving the efficiency of generating a new location set. After finishing display of the location information set, the electronic device may further provide the user with different operations for the location information set by using different operation entries of the location information set. Therefore, the user performs different operations on the location information set based on a requirement of the user, so that the location information set better meets the requirement of the user.

The foregoing descriptions are merely embodiments of the present disclosure and are not intended to limit the protection scope of the present disclosure. Any modification, equivalent replacement, or improvement made within the spirit and range of the present disclosure shall fall within the protection scope of the present disclosure.

What is claimed is:

1. A location set generation method, applied to an electronic device, the method comprising:
determining location set source information in response to a trigger operation on a location set creation entry on an application program interface;
extracting location information from the location set source information, and generating, by using the extracted location information, a location information set associated with the location set source information;
displaying a map interface, wherein the map interface comprises a map information region and a set information region; and
displaying, in the map information region, a plurality of locations in the location information set and marks corresponding to the plurality of locations, and displaying the location information set in the set information region.

2. The method according to claim 1, wherein the application program interface comprises a location editing interface; and the determining location set source information in response to a trigger operation on a location set creation entry on an application program interface comprises:
displaying an information type selection region on the location editing interface in response to the trigger operation on the location set creation entry on the location editing interface, and displaying at least two information type identifiers in the information type selection region;
displaying an information input interface corresponding to a target type identifier in response to a selection operation on the target type identifier in the at least two information type identifiers; and
determining input information on the information input interface as the location set source information in response to a trigger operation on an end input identifier on the information input interface.

3. The method according to claim 2, wherein the target type identifier comprises a text type identifier, the information input interface comprises a text editing interface, and the input information comprises text information; and
the determining input information on the information input interface as the location set source information in response to a trigger operation on an end input identifier on the information input interface comprises:
determining the text information on the text editing interface as the location set source information in response to the trigger operation on the end input identifier on the text editing interface.

4. The method according to claim 2, wherein the target type identifier comprises an image type identifier, the information input interface comprises an image upload interface, and the input information comprises image information; and
the determining input information on the information input interface as the location set source information in response to a trigger operation on an end input identifier on the information input interface comprises:
determining the image information on the image upload interface as the location set source information in response to the trigger operation on the end input identifier in the image upload interface.

5. The method according to claim 1, further comprising:
displaying the location editing interface in response to a trigger operation on a set editing identifier on the map interface, and displaying the location set creation entry on the location editing interface.

6. The method according to claim 1, wherein the application program interface comprises an information display interface; and the determining location set source information in response to a trigger operation on a location set creation entry on an application program interface comprises:
determining display information on the information display interface as the location set source information in response to the trigger operation on the location set creation entry on the information display interface.

7. The method according to claim 6, further comprising:
displaying at least one candidate application identifier on the information display interface in response to an editing operation on the display information on the information display interface; and
displaying, on the information display interface, at least one editing function entry corresponding to a map application identifier in response to a selection operation on the map application identifier in the at least one candidate application identifier, wherein the at least one editing function identifier comprises the location set creation entry.

8. The method according to claim 1, further comprising:
displaying an information editing window corresponding to a target location in response to a trigger operation on an information editing identifier of the target location in the location information set, wherein the information editing window comprises at least one information editing option;
performing editing processing corresponding to a target editing option on the target location in response to a selection operation on the target editing option in the at least one information editing option; and
updating the location information set by using the edited target location, and displaying the updated location information set in the set information region.

9. The method according to claim 1, further comprising:
displaying a proofreading preview window on the map interface in response to a trigger operation on an information proofreading identifier in the set information region; and
displaying the location set source information in the proofreading preview window.

10. The method according to claim 1, further comprising:
displaying a theme input region corresponding to the location information set in response to a trigger operation on a theme editing identifier corresponding to the location information set on the map interface; and
determining input information obtained from the theme input region as theme information of the location information set, and correspondingly storing the theme information and the location information set.

11. The method according to claim 10, further comprising:
obtaining a plurality of location information sets corresponding to a plurality of pieces of theme information in response to a trigger operation on a theme integration identifier on the map interface;
performing set recombination on the plurality of location information sets, to obtain an integrated information set of the plurality of location information sets; and
displaying the integrated information set in the set information region of the map interface.

12. The method according to claim 11, wherein the performing set recombination on the plurality of location information sets, to obtain an integrated information set of the plurality of location information sets comprises:
performing merging processing on the plurality of location information sets, to obtain the integrated information set of the plurality of location information sets; or
performing intersection calculating processing on the plurality of location information sets, to obtain the integrated information set of the plurality of location information sets; or
performing deduplication processing on the plurality of location information sets, to obtain the integrated information set of the plurality of location information sets.

13. The method according to claim 1, wherein the location set source information comprises image information; and the extracting location information from the location set source information is implemented by performing the following processing:
performing text extraction on the image information to obtain extracted text, and identifying a plurality of candidate locations from the extracted text; and
screening the plurality of candidate locations to obtain the location information.

14. The method according to claim 13, wherein the screening the plurality of candidate locations to obtain the location information comprises:
screening candidate locations that are in a same geographical range in the plurality of candidate locations, to obtain the location information; or
screening a candidate location whose confidence is higher than a confidence threshold in the plurality of candidate locations, to obtain the location information.

15. A location set generation apparatus, comprising:
a memory, configured to store computer-executable instructions; and
a processor, configured to, when executing the computer-executable instructions stored in the memory, implement:
determining location set source information in response to a trigger operation on a location set creation entry on an application program interface;
extracting location information from the location set source information, and generating, by using the extracted location information, a location information set associated with the location set source information;
displaying a map interface, wherein the map interface comprises a map information region and a set information region; and
displaying, in the map information region, a plurality of locations in the location information set and marks corresponding to the plurality of locations, and displaying the location information set in the set information region.

16. The apparatus according to claim 15, wherein the application program interface comprises a location editing interface; and the determining location set source information in response to a trigger operation on a location set creation entry on an application program interface comprises:
displaying an information type selection region on the location editing interface in response to the trigger operation on the location set creation entry on the location editing interface, and displaying at least two information type identifiers in the information type selection region;
displaying an information input interface corresponding to a target type identifier in response to a selection operation on the target type identifier in the at least two information type identifiers; and
determining input information on the information input interface as the location set source information in response to a trigger operation on an end input identifier on the information input interface.

17. The apparatus according to claim 16, wherein the target type identifier comprises a text type identifier, the information input interface comprises a text editing interface, and the input information comprises text information; and
the determining input information on the information input interface as the location set source information in response to a trigger operation on an end input identifier on the information input interface comprises:
determining the text information on the text editing interface as the location set source information in response to the trigger operation on the end input identifier on the text editing interface.

18. The apparatus according to claim 16, wherein the target type identifier comprises an image type identifier, the information input interface comprises an image upload interface, and the input information comprises image information; and
the determining input information on the information input interface as the location set source information in response to a trigger operation on an end input identifier on the information input interface comprises:
determining the image information on the image upload interface as the location set source information in response to the trigger operation on the end input identifier in the image upload interface.

19. The apparatus according to claim 15, wherein the processor is further configured to perform:
displaying the location editing interface in response to a trigger operation on a set editing identifier on the map interface, and displaying the location set creation entry on the location editing interface.

20. A non-transitory computer-readable storage medium, having computer-executable instructions stored therein, wherein the computer-executable instructions, when being executed by a processor, cause the processor to perform:
determining location set source information in response to a trigger operation on a location set creation entry on an application program interface;
extracting location information from the location set source information, and generating, by using the extracted location information, a location information set associated with the location set source information;
displaying a map interface, wherein the map interface comprises a map information region and a set information region; and
displaying, in the map information region, a plurality of locations in the location information set and marks corresponding to the plurality of locations, and displaying the location information set in the set information region.
